(19) United States
(12) Patent Application Publication
(10) Pub. No.: US 2013/0272254 A1
(43) Pub. Date: Oct. 17, 2013

(54) COMMUNICATION SYSTEM AND COMMUNICATION METHOD

(71) Applicants: Jungo Goto, Osaka-shi (JP); Hiroki Takahashi, Osaka-shi (JP); Osamu Nakamura, Osaka-shi (JP); Kazunari Yokomakura, Osaka-shi (JP); Yasuhiro Hamaguchi, Osaka-shi (JP)

(72) Inventors: Jungo Goto, Osaka-shi (JP); Hiroki Takahashi, Osaka-shi (JP); Osamu Nakamura, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 13/992,588

(22) PCT Filed: Dec. 8, 2011
(86) PCT No.: PCT/JP2011/078432

§ 371 Date: Jun. 24, 2013

(30) Foreign Application Priority Data
Dec. 10, 2010 (JP) 2010-276236

(51) Int. Cl. H04W 72/04

(52) U.S. Cl. CPC H04W 72/0406
USPC 370/329

(57) ABSTRACT

A communication system includes a first communication device that transmits a signal in the frequency domain, part of the signal being removed, and a second communication device that receives the transmitted signal. The second communication device determines a signal to be removed by the first communication device, and transmits information indicating the position of the signal to be removed. The first communication device receives the information indicating the position of the signal to be removed, removes part of the signal in the frequency domain on the basis of the information, and transmits the signal. Accordingly, clipping can be performed in accordance with the state of a channel.

### TECHNICAL FIELD

The present invention relates to a communication system and a communication method.

The present application is based on and claims priority from Japanese Patent Application No. 2010-276236 filed Dec. 10, 2010, the entire contents of which are hereby incorporated by reference.

### BACKGROUND ART

Standardization of the LTE (Long Term Evolution) system, which is the 3.9-th generation mobile phone wireless communication system, is nearly finished. Recently, standardization of LTE-A (LTE-Advanced, which may also be referred to as IMT-A), which is an enhancement of the LTE system, has been performed as a candidate for the 4-th generation wireless communication system.

In uplink (communication from a mobile station to a base station) of the LTE system, DFT-S-OFDM (Discrete Fourier Transform Spread Orthogonal Frequency Division Multiplexing, which may also be referred to as SC-FDMA (Single Carrier Frequency Division Multiple Access)), which allocates a single carrier spectrum to contiguous frequency bands, is adopted. This transmission scheme has a good PAPR (Peak to Average Power Ratio) property, compared with OFDM (Orthogonal Frequency Division Multiplexing) or the like. To improve the frequency utilization efficiency, the LTE-A system has been decided to adopt, in addition to DFT-S-OFDM, Clustered DFT-S-OFDM (which may also be referred to as dynamic spectrum control (DSC) or DFT-S-OFDM with SDC (Spectrum Division Control)), which divides a single carrier spectrum into a plurality of clusters. In Clustered DFT-S-OFDM clustered signal spectra are allocated to non-contiguous frequency bands.

In Clustered DFT-S-OFDM, which is adopted as a transmission scheme for uplink in LTE-A, the amount of control information relating to frequency allocation increases, compared with DFT-S-OFDM, which uses contiguous frequency bands. The reason is that, while allocation of contiguous frequency bands simply involves reporting of the frequency position of the start of allocation and a bandwidth, allocation of non-contiguous frequency bands must report the frequency position for each cluster, and accordingly, the amount of control information increases in accordance with the number of clusters. Therefore, to prevent an increase in the amount of control information in LTE-A, it is decided that the number of clusters in Clustered DFT-S-OFDM is limited to two, and the minimum allocation unit is made wider than that in DFT-S-OFDM (see NPL 1).

Meanwhile, clipping technique (Clipped DFT-S-OFDM, which may also be referred to as frequency domain puncturing), which is capable of improving the frequency utilization efficiency in single carrier transmission, has been proposed (see NPL 2). In clipping technique, a transmitter removes part of a single carrier spectrum and transmits the spectrum, and a receiver restores the spectrum by using turbo equalization technique utilizing a constraint of DFT of a received signal or the like. Thus, if the spectrum can be restored by using turbo equalization technique, the frequency resources to be used can be reduced without degrading the transmission performances (such as a bit error rate). This technique is also applicable to DFT-S-OFDM used in LTE-A and is a very effective technique.

### CITATION LIST

### Non Patent Literature

NPL 1: 3GPP Draft Report of 3GPP TSG RAN WG1 #62 v0.1.0
NPL 2: A. Okada, S. Ibi, and S. Sampei, “Spectrum Shaping Technique Combined with SC/MMSE Turbo Equalizer for High Spectral Efficient Broadband Wireless Access Systems,” ICSPCS2007, Gold Coast, Australia, December 2007

### DISCLOSURE OF INVENTION

### Problems to be Solved by the Invention

However, in the above-described clipping technique, a mobile station device that performs data transmission and a base station device that receives the data share channel state information, and the mobile station device performs clipping based on the channel state information. Therefore, it is necessary to report the channel state information as control information from the base station device to the mobile station device. There is a problem that control information increases.

In view of these circumstances, an object of the present invention to provide a communication system and a communication method that can perform clipping in accordance with the state of a channel while suppressing an increase in control information.

### Means for Solving the Problems

(1) The present invention has been made in order to solve the above-described problem. An aspect of the present invention is a communication system including a first communication device that transmits a signal in the frequency domain, part of the signal being removed, and a second communication device that receives the transmitted signal. The second communication device determines a signal to be removed by the first communication device, and transmits information indicating the position of the signal to be removed. The first communication device receives the information indicating the position of the signal to be removed, removes part of the signal in the frequency domain on the basis of the information, and transmits the signal.

(2) Another aspect of the present invention is the above-described communication system, wherein the second communication device determines a frequency band used by the first communication device for transmission, and the information indicating the position of the signal to be removed includes information indicating at least three frequency positions.

(3) Another aspect of the present invention is the above-described communication system, wherein the position of the signal to be removed is between two frequency positions selected, from among the three frequency positions, on the basis of a predetermined rule.

(4) Another aspect of the present invention is the above-described communication system, wherein the predetermined rule selects, from among the three frequency positions, two frequency positions with the smallest difference.

(5) Another aspect of the present invention is the above-described communication system, wherein the information indicating the position of the signal to be removed includes information indicating four frequency positions.

(6) Another aspect of the present invention is a communication method for a communication system including a first communication device that transmits a signal in the frequency domain, part of the signal being removed, and a second communication device that receives the transmitted signal. The communication method includes a first step of determining, by the second communication device, a signal to be removed by the first communication device, and transmitting information indicating the position of the signal to be removed; and a second step of receiving, by the first communication device, the information indicating the position of the signal to be removed, removing part of the signal in the frequency domain on the basis of the information, and transmitting the signal.

### Effects of the Invention

According to the present invention, clipping in accordance with the state of a channel can be performed while an increase in control information is suppressed.

### BRIEF DESCRIPTION OF THE DRAWINGS

FIG. 1 is a conceptual diagram showing the configuration of a wireless communication system 10 according to a first embodiment of the present invention.

FIG. 2 is a schematic block diagram showing the configuration of a mobile station device 11 according to the embodiment.

FIG. 3 is a conceptual diagram describing clipping according to the embodiment.

FIG. 4 is a schematic block diagram showing the configuration of a base station device 20 according to the embodiment.

FIG. 5 is a diagram showing an example of frequency band allocation according to the embodiment.

FIG. 6 is a diagram showing an example of frequency band allocation in Clustered DFT-S-OFDM in LTE-A.

FIG. 7 is a flowchart describing an operation example of a control information generator 216 and a control information transmitter 217 according to the first embodiment.

FIG. 8 is a flowchart describing an operation example of a control information processor 111 according to the embodiment.

FIG. 9 is a flowchart describing a process of extracting I₁ to I₄ by the control information processor 111 according to the embodiment.

FIG. 10 is a diagram showing an example of frequency band allocation according to a modification of the first embodiment.

FIG. 11 is a diagram showing another example of frequency band allocation according to the modification of the first embodiment.

FIG. 12 is a diagram showing an example of frequency band allocation according to a second embodiment of the present invention.

FIG. 13 is a flowchart describing an operation example of the control information generator 216 and the control information transmitter 217 according to the embodiment.

FIG. 14 is a diagram showing an example of frequency band allocation according to a modification of the second embodiment.

FIG. 15 is a diagram showing an example of frequency band allocation according to another modification of the second embodiment.

FIG. 16 is a diagram showing an example of frequency band allocation according to a third embodiment of the present invention.

FIG. 17 is a diagram showing another example of frequency band allocation according to the embodiment.

FIG. 18 is a flowchart describing the operation of the control information generator 216 and the control information transmitter 217 according to the embodiment.

FIG. 19 is a table comparing the number of bits of control information of frequency band allocation in Clustered DFT-S-OFDM in LTE-A and the embodiment.

### BEST MODE FOR CARRYING OUT THE INVENTION

### First Embodiment

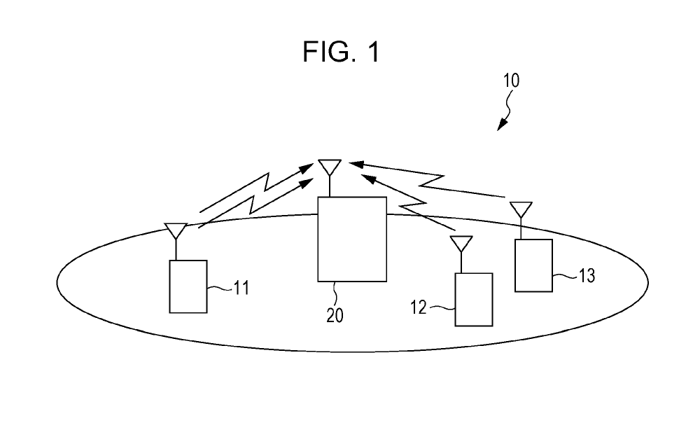

Hereinafter, a first embodiment of the present invention will be described with reference to the drawings. FIG. 1 is a conceptual diagram showing the configuration of a wireless communication system 10 according to the embodiment. The wireless communication system 10, which is a communication system according to the present embodiment, includes mobile station devices 11 (second communication device), 12, and 13, and a base station device 20 (first communication device). The base station device 20 receives transmit signals from the plurality of mobile station devices 11, 12, and 13.

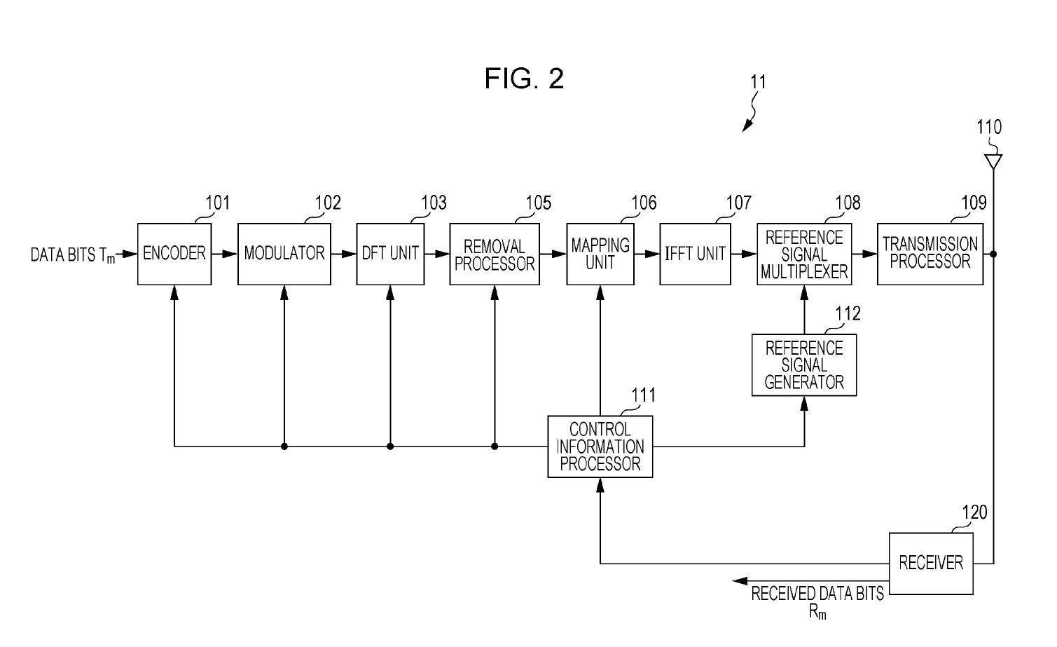

FIG. 2 is a schematic block diagram showing the configuration of the mobile station device 11. The mobile station device 11 includes an encoder 101, a modulator 102, a DFT unit 103, a removal processor 105, a mapping unit 106, an IFFT (Inverse Fast Fourier Transform) unit 107, a reference signal multiplexer 108, a transmission processor 109, an antenna 110, a control information processor 111, a reference signal generator 112, and a receiver 120. The receiver 120 downconverts a signal received by the antenna 110 from the base station device 20 to a baseband frequency. The receiver 120 demodulates the downconverted signal and obtains received data bits Rm and control information. The control information processor 111 extracts, from the control information demodulated by the receiver 120, control information to be sent as an instruction to each unit, and outputs the control information to each unit. Control information to be extracted includes control information of frequency band allocation used for data transmission, information indicating a modulation scheme (modulation level), information indicating a coding rate, or the like. Also, the control information processor 111 generates, from the control information of frequency band allocation, information indicating frequency positions to be clipped and information relating to the band of data to be transmitted. Details and a generation method of the information indicating frequency positions to be clipped and the information relating to the band of data to be transmitted will be described later.

The control information processor 111 outputs the information of a coding rate, included in the extracted control information, to the encoder 101. Also, the control information processor 111 outputs the information of a modulation level to the modulator 102. Also, the control information processor 111 outputs, to the DFT unit 103, the information relating to the band of data to be transmitted. Also, the control information processor 111 outputs the information indicating frequency positions to be clipped to the removal processor 105. Also, the control information processor 111 outputs the frequency band allocation information to the mapping unit 106 and the reference signal generator 112. The encoder 101 applies error correcting coding such as turbo codes or LDPC (Low Density Parity Check) codes to input data bits Tm, and outputs the result as code bits. The encoder 101 performs this error correcting coding in accordance with the information of a coding rate, which is output by the control information processor 111.

The modulator 102 applies modulation to the code bits by using the modulation scheme of the modulation level output by the control information processor 111, among modulation schemes such as QPSK (Quaternary Phase Shift Keying), 16QAM (16-ary Quadrature Amplitude Modulation), or the like, and generates a modulated symbol. The DFT unit 103 converts the modulated symbol string output from the modulator 102 from the time domain to a signal in the frequency domain by performing discrete Fourier transform, and outputs the signal to the removal processor 105. The DFT unit 103 regards a unit (the number of modulated symbols) subjected to discrete Fourier transform as a value in accordance with the information relating to the band of data to be transmitted, which is output by the control information processor 111.

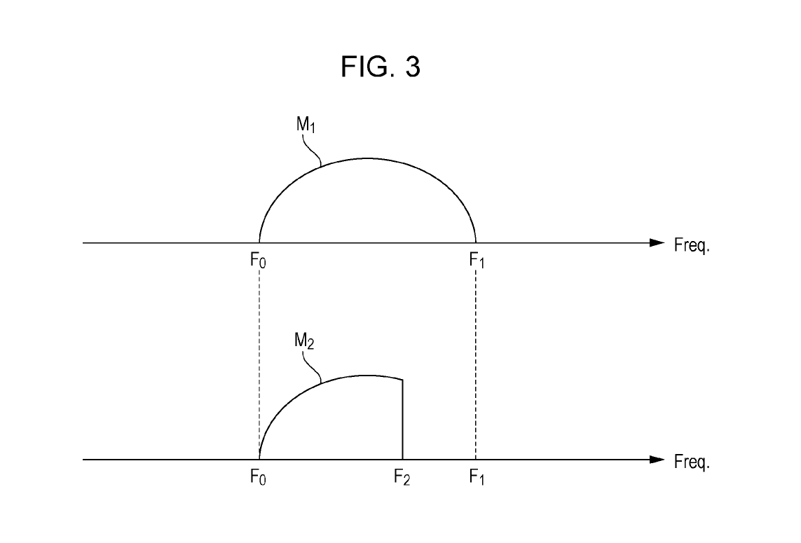

The removal processor 105 removes part of the signal in the frequency domain on the basis of the information indicating frequency positions to be clipped, which is output by the control information processor 111, and outputs the remaining signal to the mapping unit 106. Specifically, the removal processor 105 replaces part of the signal in the frequency domain (signal to be removed) with zero. For example, when the information indicating frequency positions to be clipped indicates frequencies F2 to F1, as in code M1 in FIG. 3, the removal processor 105 replaces, in a signal in the frequency domain allocated to the frequencies F0 to F1, a signal from the frequencies F2 (F0<F2<F1) to F1 with zero (zero padding), and generates a signal in the frequency domain such as code M2 in FIG. 3. Instead of replacing a signal with zero, the removal processor 105 may not output a corresponding signal to the mapping unit 106, and may output only the remaining signal.

The mapping unit 106 arranges the signal output by the removal processor 105 at frequencies indicated by the frequency band allocation information output by the control information processor 111. The IFFT unit 107 performs inverse fast Fourier transform of the signal arranged by the mapping unit 106 and converts the signal to a signal in the time domain. The reference signal multiplexer 108 performs multiplexing by arranging a demodulation reference signal corresponding to the bandwidth used for data transmission, which is input from the reference signal generator 112, in the same band as data transmission. A reference signal to be multiplexed by the reference signal multiplexer 108 is generated by the reference signal generator 112 as a signal in the frequency domain and converted to a signal in the time domain. In the present embodiment, the configuration multiplexes a reference signal in the time domain. However, the configuration may multiplex a reference signal before being converted by the IFFT unit 107 to a signal in the time domain, that is, a signal in the frequency domain.

The transmission processor 109 inserts a cyclic prefix (CP) to the signal multiplexed by the reference signal multiplexer 108 with the reference signal, and performs D/A (Digital/Analog) conversion. The transmission processor 109 further upconverts the D/A-converted analog signal to a wireless frequency. A PA (Power Amplifier) included in the transmission processor 109 amplifies the upconverted signal to transmission power, and wirelessly transmits the signal to the base station device 20 via the antenna 110.

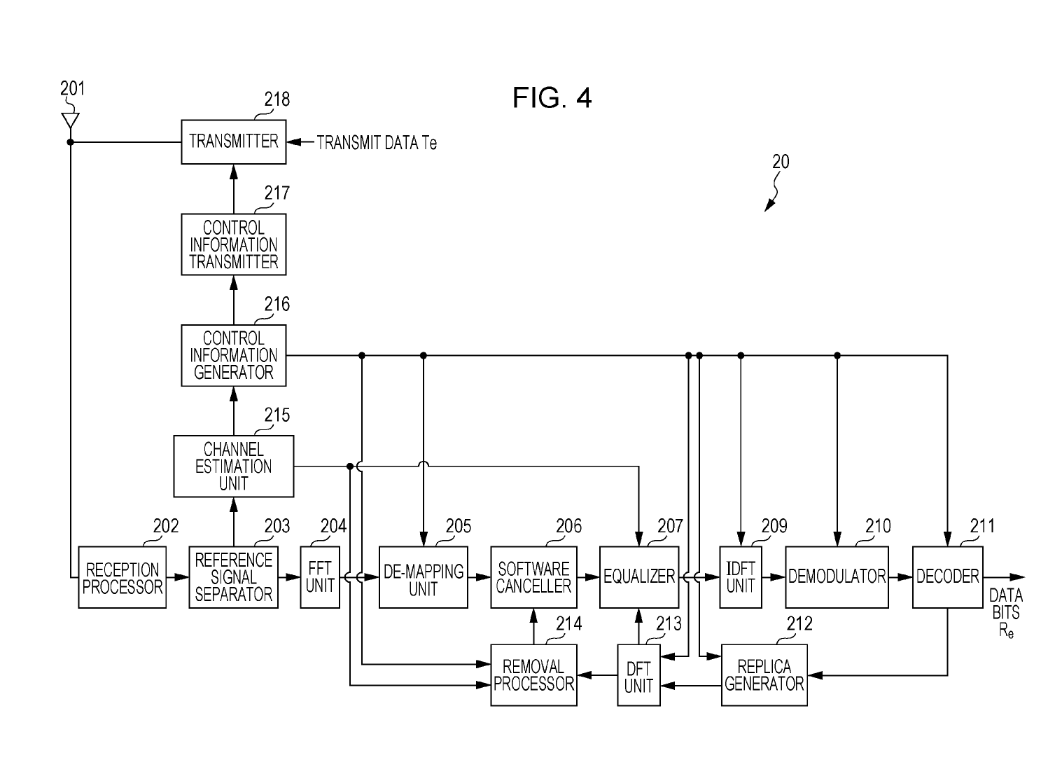

FIG. 4 is a schematic block diagram showing the configuration of the base station device 20. The base station device 20 includes an antenna 201, a reception processor 202, a reference signal separator 203, an FFT unit 204, a de-mapping unit 205, a software canceller 206, an equalizer 207, an IDFT unit 209, a demodulator 210, a decoder 211, a replica generator 212, a DFT unit 213, a removal processor 214, a channel estimation unit 215, a control information generator 216, a control information transmitter 217, and a transmitter 218.

The antenna 201 receives signals from the mobile station devices 11, 12, and 13. The reception processor 202 downconverts a signal received by the antenna 201 to a baseband frequency. The reception processor 202 converts the downconverted signal to a digital signal by performing A/D (Analogue/Digital) conversion, and eliminates a cyclic prefix from the digital signal. The reference signal separator 203 separates the signal, from which the cyclic prefix has been eliminated by the reception processor 202, into a reference signal and a data signal. The reference signal separator outputs the reference signal to the channel estimation unit 215, and outputs the data signal to the FFT unit 204.

The channel estimation unit 215 compares the reference signal output by the reference signal separator 203 with a pre-stored reference signal, and estimates the frequency response of a channel with each of the mobile station devices 11, 12, and 13. The channel estimation unit 215 outputs the estimated frequency response to the control information generator 216, the equalizer 207, and the removal processor 214. For each of the mobile station devices 11, 12, and 13, the control information generator 216 determines information such as the band of data to be transmitted, frequency positions to be clipped, frequency band allocation, a coding rate, and a modulation scheme. Also, the control information generator 216 outputs the information indicating frequency band allocation and the information indicating frequency positions to be clipped to the de-mapping unit 205. The control information generator 216 outputs the information indicating a modulation level to the demodulator 210 and the replica generator 212. The control information generator 216 outputs the information indicating a coding rate to the decoder 211. Further, the control information generator 216 outputs the information indicating frequency positions to be clipped to the removal processor 214. The control information generator 216 outputs, to the IDFT unit 209 and the DFT unit 213, the information indicating the band of data to be transmitted.

The control information transmitter 217 converts control information representing these pieces of information determined by the control information generator 216 to a format for feedback to each mobile station device. In the present embodiment, the control information transmitter 217 converts the band of data to be transmitted, frequency positions to be clipped, and frequency band allocation to frequency band allocation information. This conversion will be described in detail later. The transmitter 218 modulates the control information converted by the control information transmitter 217. Also, the transmitter 218 modulates transmission data Te to be transmitted to each mobile station device, and multiplexes the modulated transmission data Te with the modulated control information. The transmitter 218 upconverts a signal obtained as a result of this multiplexing to a wireless frequency, and transmits the signal to the mobile station devices 11, 12, and 13 via the antenna 201.

Meanwhile, the FFT unit 204 performs fast Fourier transform of the data signal separated by the reference signal separator 203 and converts the signal in the time domain to a signal in the frequency domain. Thereafter, the de-mapping unit 205, the software canceller 206, the equalizer 207, the IDFT unit 209, the demodulator 210, the decoder 211, the replica generator 212, the DFT unit 213, and the removal processor 214 perform processing of each of signals from the mobile station devices 11 to 13. Here, as a representative thereof, the case where these units perform processing of a signal from the mobile station device 11 will be described. Alternatively, instead of the case where these units perform processing of signals from the mobile station devices 11 to 13, a plurality of sets of these units may be provided, and each set may perform processing of a corresponding one of signals from the mobile station devices 11 to 13.

In accordance with the information indicating frequency band allocation, received from the control information generator 216, the de-mapping unit 205 extracts a signal in a frequency band allocated to the mobile station device 11 from the signal in the frequency domain, converted by the FFT unit 204. On the basis of the information indicating frequency positions to be clipped, the de-mapping unit 205 further generates a signal RₘₐₚεC^{N×1} by adding “0”, at clipped frequency positions, to the previously extracted signal. Here, C^{x×y} indicates a complex matrix with x rows and y columns. Also, N is a unit (the number of modulated symbols) subjected to discrete Fourier transform performed by the DFT unit 103 of the mobile station device 11. The software canceller 206 cancels a replica in the frequency domain, generated by the removal processor 214, from the signal Rₘₐₚ extracted by the de-mapping unit 205, by using the next equation (1), and generates a signal R_{residual}. The replica in the frequency domain is generated from decoded bits obtained by the decoder 211.

R_{residual}=Rₘₐₚ−PHFSₘₐₚ_{_{—}}ᵣₑₚ equation (1)

In equation (1), Sₘₐₚ_{_{—}}ᵣₑₚεC^{N×1} represents a replica in the time domain (output of the replica generator 212), generated from the decoded bits obtained by the decoder 211, FεC^{N×N} represents a Fourier transform matrix (operation by the DFT unit 213), HεC^{N×N} represents a matrix of the channel (output of the channel estimation unit 215 (operation by the removal processor 214)), and PεC^{N×N} represents a diagonal matrix of clipping (operation by the removal processor 214). Although the software canceller 206 to the removal processor 214 iteratively perform processing of the same signal, nothing is performed in software canceller processing for the first time in these iterations since there is no information obtained by the decoder 211.

Also, if the modulation scheme is, for example, QPSK, and the first bit and the second bit constituting a QPSK symbol is represented by λ₁ and λ₂, respectively, the k-th value Sₘₐₚ_{_{—}}ᵣₑₚ(k) in the time domain of the above-described software replica is calculated by the replica generator 212 using equation (2):

$$\begin{matrix}[ Math . 1 ] & \\ {s}_{ma p \_ rep} ( k ) = \frac{1}{\sqrt{2}} tanh ( \frac{{λ}_{1} ( k )}{2} ) + j \frac{1}{\sqrt{2}} tanh ( \frac{{λ}_{2} ( k )}{2} ) & equation ( 2 )\end{matrix}$$

Also, a matrix P of clipping is generated on the basis of the information indicating frequency positions to be clipped, output by the control information generator 216. P(k) with components of k rows and k columns is expressed by the next equation (3) in the case where “0” indicates an element corresponding to the frequency position of a signal to be removed by clipping, “1” indicates an element corresponding to an unremoved frequency position, and frequency positions p₁ to p₂ are clipped:

$$\begin{matrix}[ Math . 2 ] & \\ P ( k ) = \{ \begin{matrix}1 & k < {p}_{1} , {p}_{2} < k \\ 0 & {p}_{1} \leq k \leq {p}_{2}\end{matrix} \\ where {p}_{1} \leq {p}_{2} . & equation ( 3 )\end{matrix}$$

The equalizer 207 performs equalization of the signal R_{residual}εC^{N×1} including a residual interference component, which compensates for distortion of a wireless channel or suppresses the residual interference and synthesizes a desired signal (output of the DFT unit 213) by using a channel performance input from the channel estimation unit 215, and outputs the result to the IDFT unit 209. Here, equalization that compensates for distortion of a wireless channel or suppresses the residual interference is multiplication by a weight based on the MMSE (Minimum Mean Square Error) standard, a ZF (Zero Forcing) weight, or the like. If w is the weight, the equalizer 207 performs arithmetic operation indicated in equation (4) as equalization. In calculation of the weight w, the channel gain of a clipped signal is “0”.

R_{eq}_{_{—}}ₒᵤₜ=wR_{residual}+FSₘₐₚ_{_{—}}ᵣₑₚ equation (4)

where FSₘₐₚ_{_{—}}ᵣₑₚ is the output of the DFT unit 213.

The IDFT unit 209 performs inverse discrete Fourier transform of the signal output by the equalizer 207 and converts the signal in the frequency domain to a signal in the time domain. The demodulator 210 stores the information of a modulation level, which is determined by the control information generator 216 on the basis of the channel performance and which is reported to the mobile station device 11. On the basis of the information of a modulation level, the demodulator 210 performs symbol demodulation of the signal in the time domain, converted by the IDFT unit 209, and obtains code bits. On the basis of the information of a coding rate, reported to the mobile station device 11, the decoder 211 performs error correcting decoding of the code bits, and obtains the error-corrected code bits and data bits. The decoder 211 outputs the error-corrected code bits to the replica generator 212 when continuing iterations for performing turbo equalization. When a condition for terminating the iterations is satisfied, such as when a certain number of repetitions are executed or when the data bits include an error detecting code and no error is detected by the error detecting code, the iterations are terminated, and data bits Re are output.

On the basis of the modulation level received from the control information generator 216, the replica generator 212 again applies modulation to the error-corrected code bits, thereby generating a replica Sₘₐₚ_{_{—}}ᵣₑₚ in the time domain. On the basis of the information indicating the band of data to be transmitted, which is received from the control information generator 216, the DFT unit 213 performs discrete Fourier transform of the replica Sₘₐₚ_{_{—}}ᵣₑₚ in the time domain in units of the same number of symbols as the DFT unit 103 of the mobile station device 11. Accordingly, the DFT unit 213 converts the replica Sₘₐₚ_{_{—}}ᵣₑₚ in the time domain to a replica in the frequency domain FSₘₐₚ_{_{—}}ᵣₑₚ, and outputs the replica in the frequency domain FSₘₐₚ_{_{—}}ᵣₑₚ to the equalizer 207 and the removal processor 214. Using the information indicating frequency positions to be clipped, which is received from the control information generator 216, and the frequency response received from the channel estimation unit 215, the removal processor 214 calculates PHFSₘₐₚ_{_{—}}ᵣₑₚ, which is a replica of a signal received by the base station device 20, from the output of the DFT unit 213.

As described above, for each mobile station device, the control information generator 216 determines information such as the band of data to be transmitted, frequency positions to be clipped, frequency band allocation, a coding rate, and a modulation scheme. The control information transmitter 217 performs format conversion for transmitting these pieces of information. Since a known format used in LTE, LTE-A, or the like is used as a format for transmitting the coding rate and the modulation scheme in the present embodiment, a detailed description thereof is omitted. A format for transmitting the information of the band of data to be transmitted, frequency positions to be clipped, and frequency band allocation will be described. In the present embodiment, bands used by the mobile station device 11 for data transmission are contiguous frequency bands. Also, frequency positions to be clipped are contiguous regions, from the lowest frequency side, in the conversion result obtained by the DFT unit 103 of the mobile station device 11.

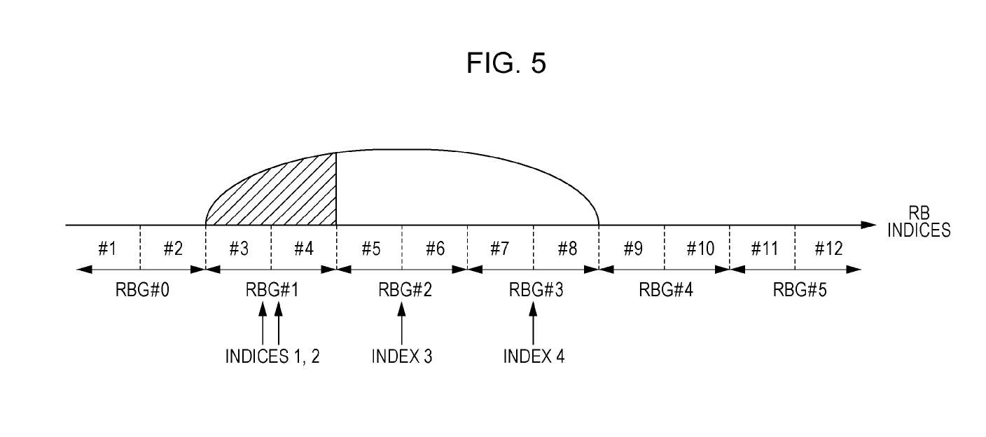

FIG. 5 is a diagram showing an example of frequency band allocation according to the present embodiment. In the present embodiment and the following embodiments, frequency band allocation is allocation in units of resource block groups. A resource block group is obtained by dividing a system band, starting from an end thereof, into units of a certain number of resource blocks. A resource block is a region with a width corresponding to a certain number of sub-carriers in the frequency domain and a certain number of OFDM symbols in the time domain. In the present embodiment and the following embodiments, the certain number of sub-carriers is 12, and the certain number of OFDM symbols is 14.

In FIG. 5, the axis of abscissas is the frequency axis, and RB indices are indices assigned to the individual resource blocks in ascending order of frequency. The RB indices are each represented here by writing a numeral indicating an index number subsequent to #. Also, RBG indices, which are indices starting from 0, are assigned to the resource block groups in ascending order of frequency. The RBG indices are each represented here by writing a numeral indicating an index number subsequent to RBG#. For example, the RBG index of the third resource block group in ascending order of frequency is represented as “RBG#2”.

In the example shown in FIG. 5, it is shown that RBG#2 and RBG#3 are allocated as frequency bands used for data transmission, and a signal corresponding to a hatched region in the diagram, that is, one resource block group on the low frequency side, is clipped. At this time, as control information of frequency band allocation, which represents information of the band of data to be transmitted, frequency positions to be clipped, and frequency band allocation, the control information transmitter 217 reports four RBG indices (indices 1 to 4; hereinafter represented as I₁, I₂, I₃, and I₄) shown in FIG. 5. As control information of frequency band allocation, the control information transmitter 217 does not report the values of the RBG indices I₁, I₂, I₃, and I₄ themselves, but reports reporting data TI₁, TI₂, TI₃, and TI₄ obtained by converting the numerals I₁, I₂, I₃, and I₄ in accordance with equations (5).

Note that I₁ and I₂ indicate the start position of frequencies (resource block group) in the case where a signal before being subjected to removal processing (clipping) is allocated, I₃ indicates the start position of frequencies actually used for transmission, and I₄ indicates the end position of frequencies actually used for transmission.

[Math. 3]

TI₁=I₁

TI₂=I₂+1

TI₃=I₃+1

TI₄=I₄+1 equations (5)

Note that 1 is added to I₂, I₃, and I₄ in order to use equation (6) for reporting four different numerals. By performing reporting as in equations (5), reporting can be performed even when the number of RBGs to be clipped is 1.

Using the above-described reporting data TI₁, TI₂, TI₃, and TI₄, the control information transmitter 217 performs arithmetic operation of equation (6), and outputs the obtained result FG, which serves as control information of frequency band allocation to be transmitted, to the transmitter 218.

$$\begin{matrix}[ Math . 4 ] & \\ FG = {\sum }_{i = 0}^{3} 〈 \begin{matrix}{N}_{RBG} - {TI}_{i + 1} \\ 4 - i\end{matrix} 〉 & equation ( 6 )\end{matrix}$$

where

$$〈 \begin{matrix}X \\ Y\end{matrix} 〉$$

is a calculation of a combination, means

$$\frac{X ( X - 1 ) ( X - 2 ) … ( X - Y + 1 )}{Y ( Y - 1 ) ( Y - 2 ) … 3 * 2 * 1} ,$$

and is 0 when X<Y.

N_{RBG} is a value obtained from P, which is the number of RBs constituting an RBG, and N, which represents the number of all RBs, by using the following equation (7):

N_{RBG}=ceil(N/P) equation (7)

For example, in the example in FIG. 5, TI₁=I₁=1, TI₂=I₂+1=1+1=2, TI₃=I₃+1=2+1=3, and TI₄=1=3+1=4. If N_{RBG}=8, when these are substituted in equation (6), the following equation (8) is obtained, and control information of frequency band allocation to be reported is “69”.

$$\begin{matrix}[ Math . 5 ] & \\ \begin{matrix}FG = 〈 \begin{matrix}8 - 1 \\ 4\end{matrix} 〉 + 〈 \begin{matrix}8 - 2 \\ 3\end{matrix} 〉 + 〈 \begin{matrix}8 - 3 \\ 2\end{matrix} 〉 + 〈 \begin{matrix}8 - 4 \\ 1\end{matrix} 〉 \\ = 35 + 20 + 10 + 4 \\ = 69\end{matrix} & equation ( 8 )\end{matrix}$$

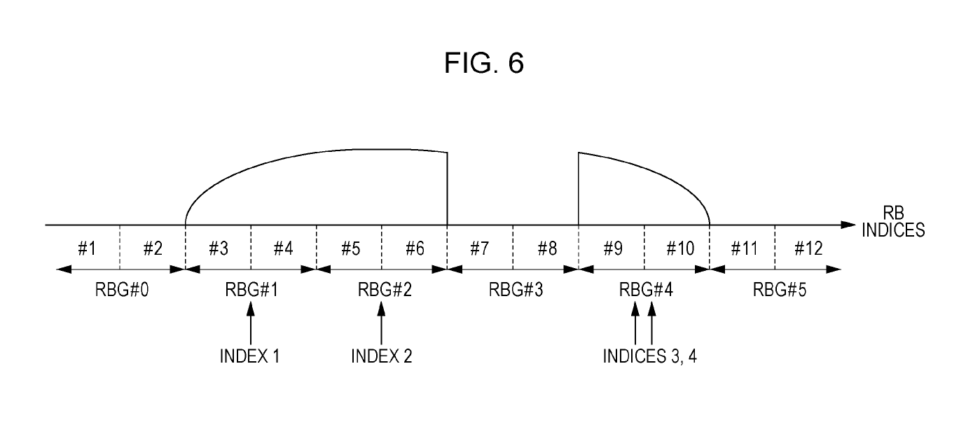

Note that equation (6) has the same format as control information of frequency band allocation when transmission based on Clustered DFT-S-OFDM is performed in LTE-A. In transmission based on Clustered DFT-S-OFDM in LTE-A, a mobile station device arranges a signal in two contiguous frequency bands (RBG#1 to RBG#2 and RBG#4), as shown in FIG. 6. The RBG indices of the start positions of the two contiguous frequency bands and RBG indices following the end positions serve as reporting data TI₁, TI₂, TI₃, and TI₄. That is, a base station device in LTE-A substitutes TI₁=1, TI₂=3, TI₃=4, and TI₄=5 in equation (6), and reports the obtained FG as control information of frequency band allocation to the mobile base station. Note that the following equations (9) are used to calculate TI₁ to TI₄ from I₁ to I₄:

[Math. 6]

TI₁=I₁

TI₂=I₂+1

TI₃=I₃

TI₄=I₄+1 equations (9)

As described above, control information of frequency band allocation in the present embodiment and control information of frequency band allocation in Clustered DFT-S-OFDM in LTE-A have the same format. There is no need to add a new format in transition from LTE-A to a system using the present embodiment. Because the format is the same, the number of bits of control information of frequency band allocation is also the same.

The number of bits of control information of frequency band allocation is expressed by the following expression (10):

ceil(log₂((N_{RBG}+1)N_{RBG}(N_{RBG}−1)(N_{RBG}−2)/4!)) expression (10)

where X! is a factorial of X.

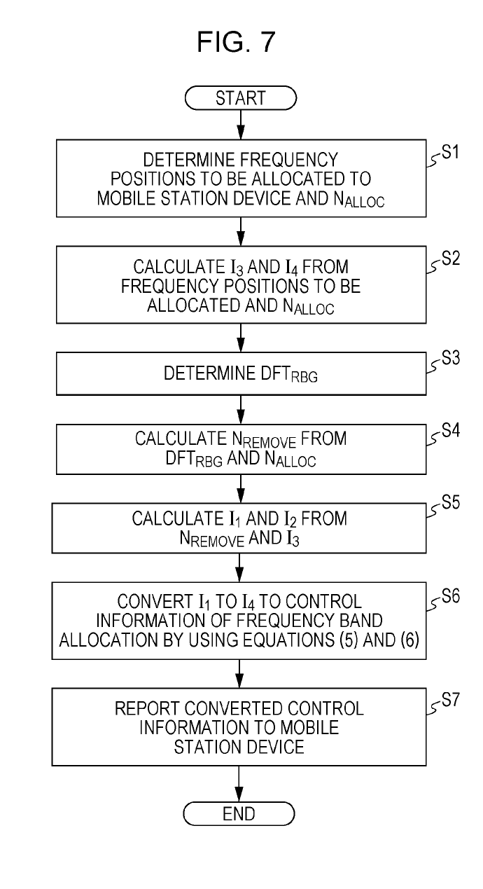

FIG. 7 is a flowchart describing an operation example of the control information generator 216 and the control information transmitter 217. Firstly, the control information generator 216 determines frequency positions to be allocated to the mobile station device and a frequency bandwidth N_{ALLOC} to be allocated to the mobile station device (S1) where N_{ALLOC} is an integer greater than 1. These determinations are performed by taking into consideration the channel performance of the mobile station device 11 and the channel performance of another mobile station device to which data is transmitted at the same time in frequency multiplexing, as is conventionally done. For example, the performance of a channel is estimated on the basis of a reference signal from each mobile station device, and a frequency band with a favorable channel performance is allocated to each mobile station device. Next, the control information transmitter 217 calculates I₃ and I₄ from the frequency positions to be allocated and the frequency bandwidth N_{ALLOC} (S2).

Next, the control information generator 216 determines DFT_{RBG} which expresses the band of data to be transmitted as the number of resource block groups (S3). This determination is the same as the conventional determination of a modulation scheme and a coding rate. The proportion of a signal to be clipped is determined, and the band DFT_{RBG} of data to be transmitted is calculated from this proportion and the frequency bandwidth N_{ALLOC}. More specifically, an association between a channel performance and a combination of a modulation scheme, coding, and the proportion of a signal to be clipped, which satisfies a certain error rate in the case of the channel performance, is stored, and a combination stored in association with the estimated channel performance is used. The result of dividing the frequency bandwidth N_{ALLOC} by the proportion of a signal to be clipped, which is included in the combination, serves as DFT_{RBG}.

Next, the control information transmitter 217 calculates N_{REMOVE}, which is a frequency bandwidth (number of resource block groups) to be clipped, by subtracting N_{ALLOC} from DFT_{RBG} (S4). The control information transmitter 217 calculates I₁ and I₂ by subtracting N_{REMOVE} from I₃ (S5). The control information transmitter 217 converts I₁ to I₄ to control information of frequency band allocation by using equations (5) and (6) (S6). The control information transmitter 217 outputs the converted control information to the transmitter 218 and transmits the control information to the mobile station device 11 (S7).

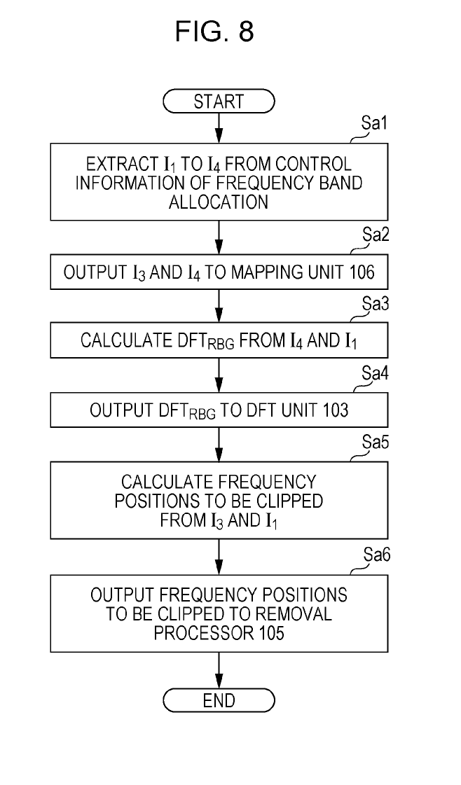

FIG. 8 is a flowchart describing an operation example of the control information processor 111. Firstly, the control information processor 111 extracts I₁ to I₄ from the control information FG of frequency band allocation, among pieces of control information received from the receiver 120 (Sa1). Next, the control information processor 111 outputs I₃ and I₄ as information of frequency band allocation to the mapping unit 106 (Sa2). At this time, the values to be reported may not be the values of RBG indices, but may be values converted to the indices of sub-carriers.

Next, the control information processor 111 calculates DFT_{RBG} from I₄ and I₁ by performing arithmetic operation of equation (11) (Sa3):

DFT_{RBG}=I₄−I₁+1 equation (11)

The control information processor 111 outputs the calculated DFT_{RBG} to the DFT unit 103 (Sa4). At this time, the value to be reported may not be the number of resource block groups, but may be a value converted to the number of sub-carriers.

Next, the control information processor 111 calculates frequency positions to be clipped from I₃ and I₁ (Sa5). That is, N_{REMOVE} is calculated using equation (12), and N_{REMOVE}, starting from the lowest frequency side, in the conversion result obtained by the DFT unit 103 serves as frequency positions to be clipped:

N_{REMOVE}=I₃−I₁ equation (12)

The control information processor 111 outputs N_{REMOVE} as frequency positions to be clipped to the removal processor 105 (Sa6). At this time, the value N_{REMOVE} to be reported may be a value converted to the number of sub-carriers, instead of the number of resource block groups.

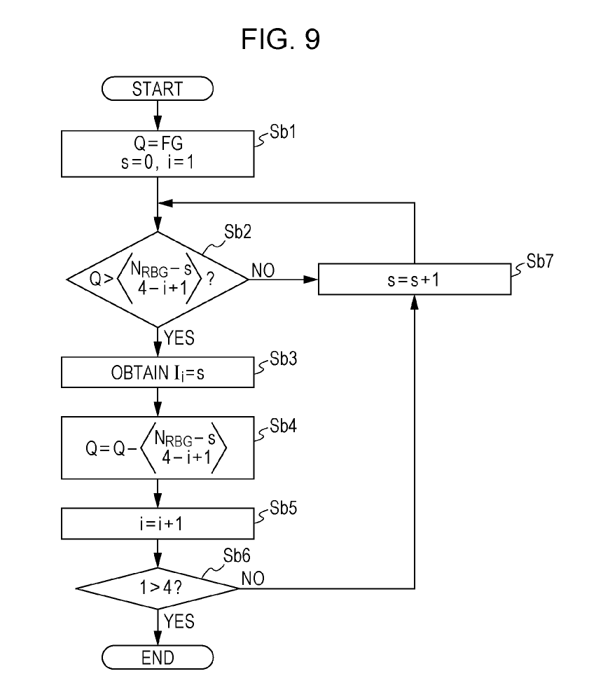

FIG. 9 is a flowchart describing a process of extracting I₁ to I₄ from the control information FG in step Sa1. Firstly, the control information processor 111 substitutes the value of the control information FG as an initial value of a variable Q, substitutes “0” as an initial value of a variable s of an RBG index candidate, and substitutes “1” as an initial value of a variable i of an RBG index number (Sb1). Next, in step Sb2, the control information processor 111 determines whether expression (13) is satisfied:

$$\begin{matrix}[ Math . 7 ] & \\ Q > 〈 \begin{matrix}{N}_{RGB} - s \\ 4 - i + 1\end{matrix} 〉 & expression ( 13 )\end{matrix}$$

When it is determined that expression (13) is not satisfied, the control information processor 111 determines that s is not a specified index and proceeds to step Sb7. In step Sb7, the control information processor 111 adds 1 to s in order to check the next index candidate, and returns to step Sb2. In contrast, when it is determined in step Sb2 that expression (13) is satisfied, the control information processor 111 proceeds to step Sb3 and determines and stores that Iᵢ is s. Next, the control information processor 111 updates Q to a value obtained by subtracting the right side from the left side of expression (13) in order to check the next index candidate (Sb4). Next, the control information processor 111 adds 1 to i (Sb5). Next, the control information processor 111 determines whether i is greater than “4” (Sb6). When it is determined that i is not greater than “4”, it means that the four indices are not determined, and the process returns to step Sb7. Alternatively, when it is determined in step Sb6 that i is greater than “4”, it means that the four indices are determined, and the process ends. With the above flow, the four RBG indices are obtained from the value reported from the control information FG.

Also, each mobile station device may share in advance with the base station device 20 whether to perform clipping and then transmission or to perform transmission using Clustered DFT-S-OFDM in LTE-A, by using a protocol in a higher layer than a physical layer. In this case, on the basis of this shared information, the control information processor 111 determines whether to process the control information of frequency band allocation as information indicating frequency band allocation in the case where clipping is performed, as described above, or to process the control information of frequency band allocation as control information of frequency band allocation in Clustered DFT-S-OFDM in LTE-A.

As described above, since the information indicating frequency positions to be clipped, determined by the control information generator 216 of the base station device 20, is reported to the mobile station device 11, and the removal processor 105 of the mobile station device 11 performs clipping in accordance with the information, clipping in accordance with the state of the channel can be performed.

Also, because the information indicating frequency positions to be clipped is included in control information of frequency band allocation in the same format (four indices) as control information of frequency band allocation in Clustered DFT-S-OFDM in LTE-A, there is no need to add a new format in transition from LTE-A to a system using the present embodiment. Because the format is the same, the number of bits of control information of frequency band allocation is also the same. Therefore, reduction of transmission efficiency caused by an increase in control information can be prevented.

### [Modification of First Embodiment]

In the first embodiment, as shown in FIG. 5, frequency positions to be clipped are contiguous regions starting from the lowest frequency side. Alternatively, frequency positions to be clipped may be contiguous regions starting from the highest frequency side. Whether the frequency positions to be clipped are from the lowest side or the highest side is shared in advance between the base station device 20 and the mobile station devices 11, 12, and 13.

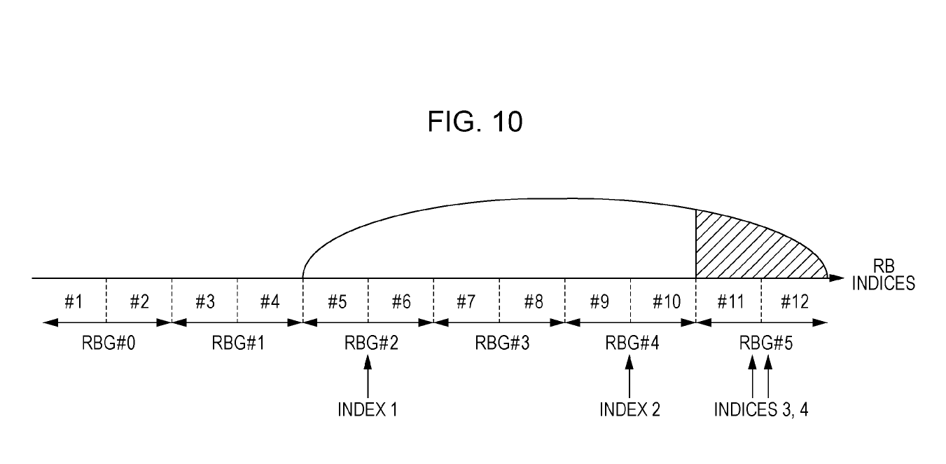

FIG. 10 is a diagram showing an example of frequency band allocation according to the present modification. In FIG. 10, the axis of abscissas is the frequency axis. Also, it is shown that frequency bands from RBG#2 to RBG#4 are allocated, and one resource block group on the higher frequency side is clipped. At this time, I₃ and I₄ indicate the end position of frequencies (resource block group) in the case where a signal before being subjected to removal processing (clipping) is allocated, I₁ indicates the start position of frequencies actually used for transmission, and I₂ indicates the end position of frequencies actually used for transmission. In the present modification, the following equations (14) are used instead of equations (5) in the first embodiment:

[Math. 8]

TI₁=I₁

TI₂=I₂

TI₃=I₃

TI₄+I₄=1 equations (14)

In the example in FIG. 10, I₁ to I₄ are RBG#2, 4, 5, and 5, and when these are substituted in equations (14), TI₁ to TI₄ become 2, 4, 5, and 6. As in the first embodiment, these are substituted in equation (6) to generate control information of frequency band allocation.

The control information processor 111 of the mobile station device 11 in the present modification outputs I₁ and I₂ to the mapping unit 106, and calculates frequency positions to be clipped from I₂ and I₄. That is, N_{REMOVE} is calculated using equation (15), and N_{REMOVE}, from the highest frequency side, in the conversion result obtained by the DFT unit 103 serves as frequency positions to be clipped.

N_{REMOVE}=I₄−I₂ equation (15)

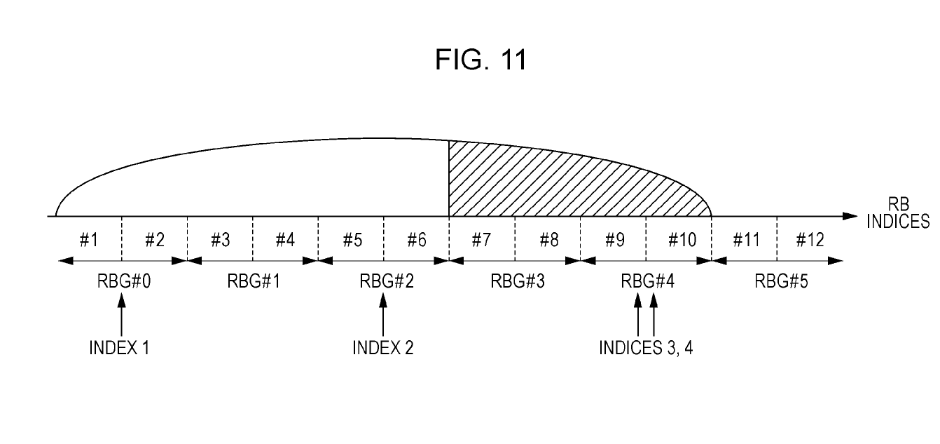

Although the examples where the number of resource block groups to be removed is one has been discussed in the first embodiment and its modification, a plurality of resource block groups may be removed within a range where N_{ALLOC}>1 is satisfied. FIG. 11 is an example in the case where two resource blocks are removed in the first embodiment and its modification. In this example, RBG#0 to RBG#2 are allocated, and frequency positions corresponding to RBG#3 and 4 are clipped. In this case, RBG#0, 2, 4, and 4 are reported as I₁ to I₄.

In this manner, the same advantageous effects as those in the first embodiment can also be achieved in the modification of the first embodiment.

### Second Embodiment

Hereinafter, a second embodiment of the present invention will be described with reference to the drawings. The first embodiment discusses the case where contiguous regions starting from the lowest side of a signal in the frequency domain are clipped. The modification of the first embodiment discusses the case where contiguous regions starting from the highest side are clipped. In the present embodiment, two sides of a signal in the frequency domain are removed. The wireless communication system 10 according to the present embodiment is different from the wireless communication system 10 according to the first embodiment only in the functions of the control information generator 216 and the control information transmitter 217 of the base station device 20 and the control information processor 111 of each of the mobile station devices 11, 12, and 13.

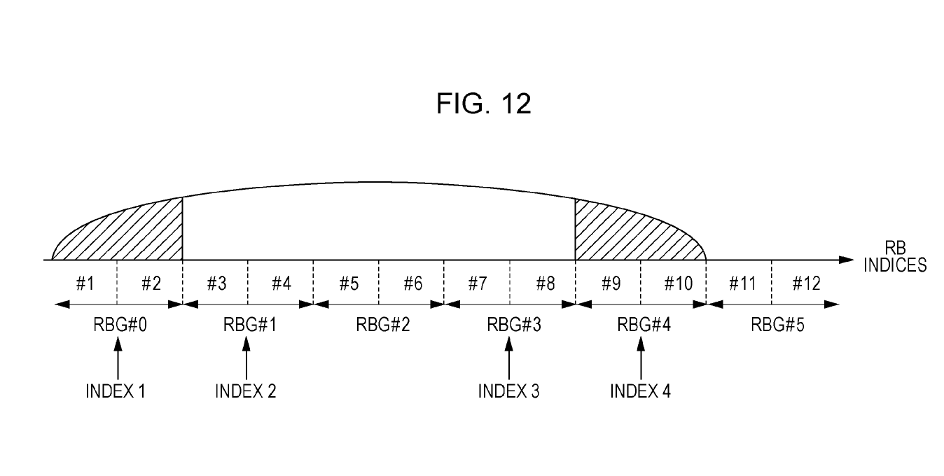

FIG. 12 is a diagram showing an example of frequency band allocation according to the present embodiment. In the example shown in FIG. 12, it is shown that RBG#1(I₂) to RBG#3(I₃) are allocated as frequency bands used for data transmission, and hatched regions in the diagram, that is, RBG#0(I₁) to RBG#1(I₂)−1 and RBG#3(I₃)+1 to RBG#4(I₄), are clipped. At this time, as control information of frequency band allocation, which represents information of the band of data to be transmitted, frequency positions to be clipped, and frequency band allocation, the control information transmitter 217 reports four RBG indices (I₁, I₂, I₃, and I₄) shown in FIG. 12, as in the first embodiment.

Note that I₁ is the start position of frequencies in the case where a signal before being subjected to removal processing is allocated, I₂ and I₃ are the start and end positions of frequencies actually used for transmission, and I₄ is the end position of frequencies in the case where a signal before being subjected to removal processing is allocated. In the present embodiment, the following equations (16) are used instead of equations (5) in the first embodiment:

[Math. 9]

TI₁=I₁

TI₂=I₂+1

TI₃=I₃

TI₄=I₄+1 equations (16)

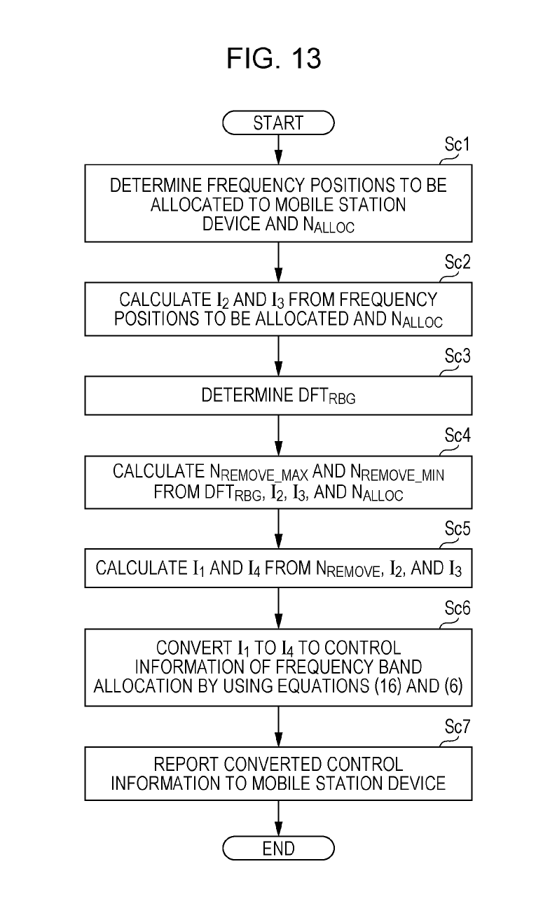

FIG. 13 is a flowchart describing an operation example of the control information generator 216 and the control information transmitter 217. Firstly, the control information generator 216 determines frequency positions to be allocated to the mobile station device and a frequency bandwidth N_{ALLOC} to be allocated to the mobile station device (Sc1). Next, the control information transmitter 217 calculates I₂ and I₃ from the frequency positions to be allocated and the frequency bandwidth N_{ALLOC} (Sc2). Next, the control information generator 216 determines DFT_{RBG} which expresses the band of data to be transmitted as the number of resource block groups (Sc3). Since the length of a signal in the frequency domain to be clipped is uniquely determined from DFT_{RBG} and N_{ALLOC}, the length is substantially determined in step Sc3.

Next, the control information generator 216 calculates, from DFT_{RBG}, I₂, I₃, and N_{ALLOC}, N_{REMOVE}_{_{—}}_{MAX}, which is the number of resource block groups on the higher frequency side, and N_{REMOVE}_{_{—}}_{MIN}, which is the number of resource block groups on the lower frequency side, among resource block groups to be clipped (Sc4). For example, the number of resource block groups to be clipped is obtained by subtracting N_{ALLOC} from DFT_{RBG}. The subtraction result is halved to obtain N_{REMOVE}_{_{—}}_{MAX} and N_{REMOVE}_{_{—}}_{MIN}. If the number of resource block groups to be clipped is an odd number, one of N_{REMOVE}_{_{—}}_{MAX} and N_{REMOVE}_{_{—}}_{MIN} is a halved value whose fractions are rounded down, and the other is a halved value whose fractions are rounded up. Next, the control information transmitter 217 calculates, from N_{REMOVE}_{_{—}}_{MAX}, N_{REMOVE}_{_{—}}_{MIN}, I₂, and I₃, the frequency positions I₁ and I₄ of the start and end of allocation in the case where clipping is not performed (Sc5). The control information transmitter 217 converts I₁ to I₄ determined in steps up to step Sb5 to control information of frequency band allocation by using equations (16) and (6) (Sc6), outputs the control information to the transmitter 218, and reports the control information to the mobile station device (Sc7).

Although DFT_{RBG} is determined after determination of the frequency positions to be allocated and N_{ALLOC} in the process of determining I₁ to I₄ in the present embodiment, these may be determined in different steps. For example, DFT_{RBG} which is the length of data to be transmitted and the frequency positions to be allocated may be determined, N_{REMOVE}_{_{—}}_{MAX} and N_{REMOVE}_{_{—}}_{MIN} may be determined on the basis of allocation to other mobile stations and channel state information, and N_{ALLOC} and I₁ to I₄ may be determined from these pieces of information.

The control information processor 111 of the mobile station device 11 in the present embodiment outputs I₂ and I₃ to the mapping unit 106, and calculates frequency positions to be clipped from I₁, I₂, I₃, and I₄. That is, N_{REMOVE}_{_{—}}_{MIN} and N_{REMOVE}_{_{—}}_{MAX} are calculated using equations (17) and (17′), and N_{REMOVE}_{_{—}}_{MAX}, from the highest frequency side, and N_{REMOVE}_{_{—}}_{MIN}, from the lowest frequency side, in the conversion result obtained by the DFT unit 103 serve as frequency positions to be clipped:

N_{REMOVE}_{_{—}}_{MIN}=I₂−I₁ equation (17)

N_{REMOVE}_{_{—}}_{MAX}=I₄−I₃ equation (17′)

As described above, since the information indicating frequency positions to be clipped, determined by the control information generator 216 of the base station device 20, is reported to the mobile station device 11, and the removal processor 105 of the mobile station device 11 performs clipping in accordance with this information, clipping in accordance with the state of the channel can be performed.

Also, because the information indicating frequency positions to be clipped is included in control information of frequency band allocation in the same format (four indices) as control information of frequency band allocation in Clustered DFT-S-OFDM in LTE-A, there is no need to add a new format in transition from LTE-A to a system using the present embodiment. Because the format is the same, the number of bits of control information of frequency band allocation is also the same. Therefore, reduction of transmission efficiency caused by an increase in control information can be prevented.

### [Modification of Second Embodiment]

In the second embodiment, as shown in FIG. 12, frequency positions to be clipped are contiguous regions starting from the lowest frequency side and contiguous regions starting from the highest frequency side. Alternatively, frequency positions to be clipped may be intermediate regions.

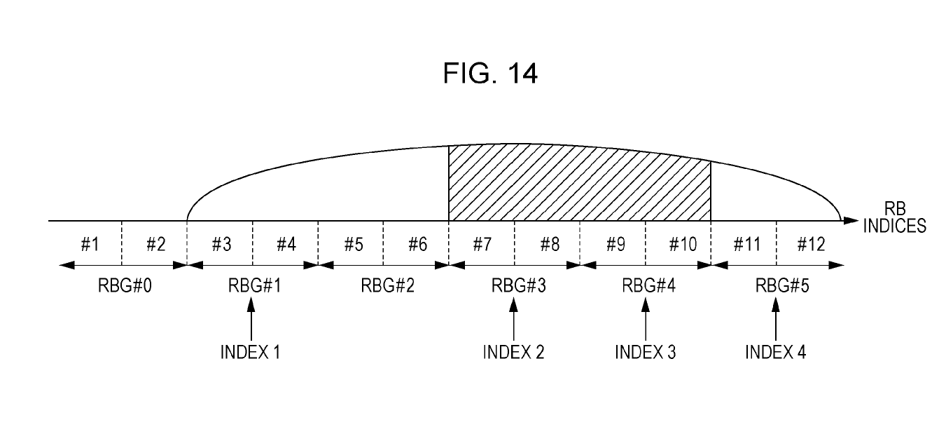

FIG. 14 is a diagram showing an example of frequency band allocation according to the present modification. In FIG. 14, the axis of abscissas is the frequency axis. It is shown that frequency bands of RBG#1(I₁), RBG#2, and RBG#5(I₄) are allocated, and a signal corresponding to intermediate regions, that is, RBG#3(I₂) and RBG#4(I₃), is clipped. At this time, I₁ is the start position of frequencies (resource source blocks) actually used for transmission, I₂ is the start position of frequencies subjected to removal processing (clipping), I₃ is the end position of frequencies subjected to removal processing (clipping), and I₄ is the end position of frequencies actually used for transmission.

In the present modification, equations (18) are used instead of equations (16) in the second embodiment. In the example in FIG. 14, I₁ to I₄ are RBG#1, 3, 4, and 5, and, when these are substituted in equations (18), TI₁ to TI₄ become 1, 3, 5, and 6. As in the second embodiment, these are substituted in equation (6) to generate control information of frequency band allocation.

[Math. 10]

TI₁=I₁

TI₂=I₂

TI₃=I₃+1

TI₄=I₄+1 equations (18)

The control information processor 111 of the mobile station device 11 in the present modification outputs I₁ to I₂−1 and I₃+1 to I₄ to the mapping unit 106, and calculates frequency positions to be clipped from I₂ and I₃. That is, N_{REMOVE} is calculated using equation (19), and I₂ to N_{REMOVE} in the conversion result obtained by the DFT unit 103 serve as frequency positions to be clipped:

N_{REMOVE}=I₃−I₂+1 equation (19)

In this manner, the same advantageous effects as those in the second embodiment can also be achieved in the modification of the second embodiment.

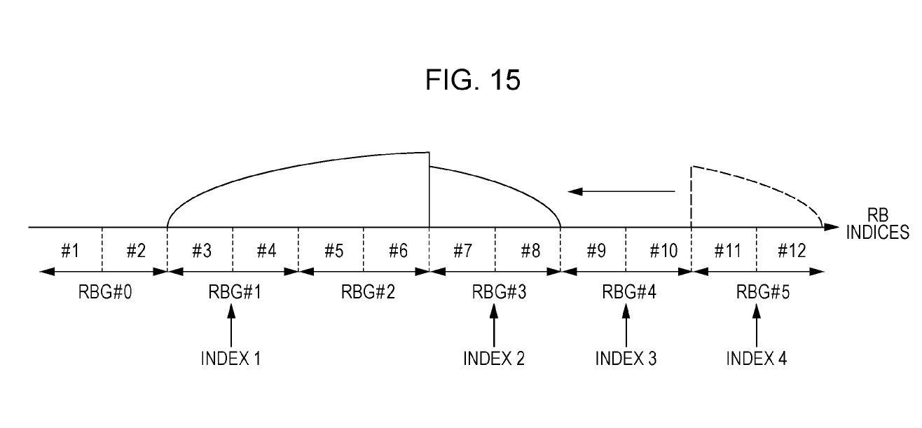

Also, when intermediate regions of a signal in the frequency domain are to be removed, instead of non-contiguously using bands, contiguous bands from RBG#1 to RBG#3 may be used by performing shifting, as in FIG. 15.

### Third Embodiment

Hereinafter, a third embodiment of the present invention will be described with reference to the drawings. The present embodiment is an example in which control information of frequency band allocation in the case where part of a signal in the frequency domain is removed is represented by using a fewer number of bits than in the first and second embodiments, that is, a fewer number of bits than in Clustered DFT-S-OFDM in LTE-A. The wireless communication system 10 according to the present embodiment is different from the wireless communication system 10 according to the first embodiment only in the functions of the control information generator 216 and the control information transmitter 217 of the base station device 20 and the control information processor 111 of each of the mobile station devices 11, 12, and 13.

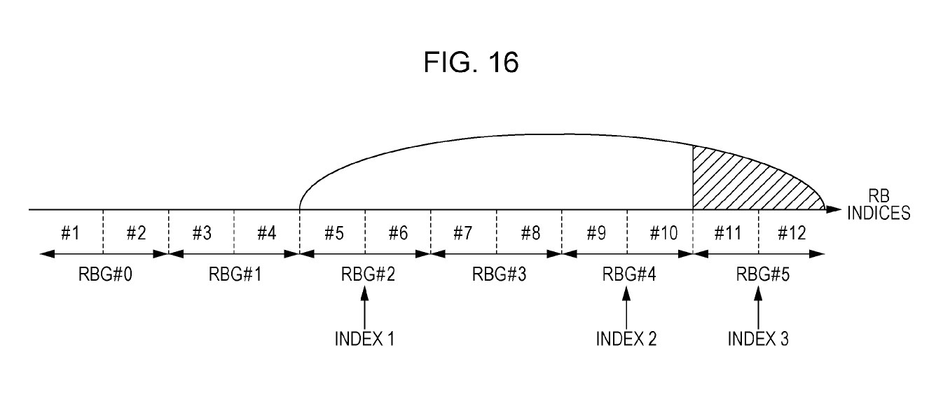

In the present embodiment, as in the first and second embodiments, frequency band allocation is performed in units of resource block groups. Unlike the first and second embodiments, only three RBG indices are reported. These three points represent a frequency band to be allocated and frequency positions to be clipped. In the present embodiment, out of a frequency band represented by an intermediate point among the three points and a point of the greatest frequency and a frequency band represented by the intermediate point and a point of the smallest frequency, a narrower frequency band serves as frequency positions to be clipped. A wider frequency band serves as a frequency band to be allocated. FIG. 16 is a diagram showing an example of frequency band allocation according to the present embodiment. In the example shown in FIG. 16, RBG#2(I₁), RBG#4(I₂), and RBG#5(I₃) are reported. Out of frequency bands represented by these three points, RBG#2(I₁) to RBG#4(I₂), which is a wider frequency band, is allocated as a frequency band used for data transmission. Also, it is shown that a signal corresponding to a hatched region in the diagram, which is a narrower frequency band, that is, RBG#5(I₃) which is a resource block group adjacent to the allocated frequency band and which is adjacent on the higher frequency side, is clipped. At this time, as control information of frequency band allocation, which represents information of the band of data to be transmitted, frequency positions to be clipped, and frequency band allocation, the control information transmitter 217 reports three RBG indices (I₁, I₂, and I₃) shown in FIG. 16.

Note that band allocation and frequency positions to be clipped based on I₁ to I₃ are determined by the following equations:

N_{REMOVE}=min{I₂−I₁+1,I₃−I₂} equation (20)

N_{ALLOC}=max{I₂−I₁+1,I₃−I₂} equation (21)

where min {A, B} represents a smaller value out of A and B, and max {A, B} represents a greater value out of A and B.

As control information of frequency band allocation, the control information transmitter 217 does not report the values of the RBG indices I₁, I₂, and I₃ themselves, but reports reporting data TI₁, TI₂, and TI₃ obtained by converting the numerals I₁, I₂, and I₃ in accordance with equations (22):

[Math. 11]

TI₁=I₁

TI₂=I₂+1

TI₃=I₃+1 equations (22)

Using the above-described reporting data TI₁, TI₂, and TI₃, the control information transmitter 217 performs arithmetic operation of equation (23), and outputs the obtained result FG, which serves as control information of frequency band allocation to be transmitted, to the transmitter 218.

$$\begin{matrix}[ Math . 12 ] & \\ FG = {\sum }_{i = 0}^{2} 〈 \begin{matrix}{N}_{RGB} - {TI}_{i + 1} \\ 3 - i\end{matrix} 〉 & equation ( 23 )\end{matrix}$$

For example, in the example in FIG. 16, TI₁=I₁=2, TI₂=I₂+1=4+1=5, and TI₃=I₃+1=5+1=6. If N_{RBG}=8, when these are substituted in equation (23), the following equation (24) is obtained, and control information of frequency band allocation to be reported is “25”.

$$\begin{matrix}[ Math . 13 ] & \\ \begin{matrix}FG = 〈 \begin{matrix}8 - 2 \\ 3\end{matrix} 〉 + 〈 \begin{matrix}8 - 5 \\ 2\end{matrix} 〉 + 〈 \begin{matrix}8 - 6 \\ 1\end{matrix} 〉 \\ = 20 + 3 + 2 \\ = 25\end{matrix} & equation ( 24 )\end{matrix}$$

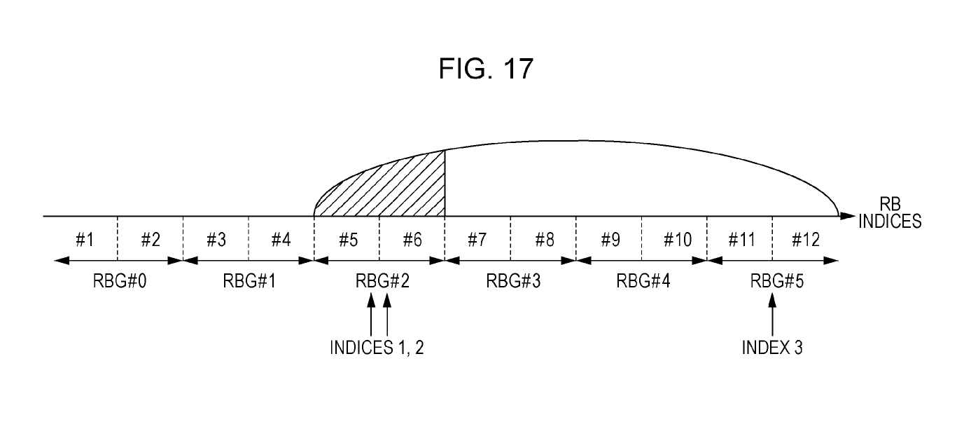

FIG. 17 is a diagram showing another example of frequency band allocation according to the present embodiment. In the example shown in FIG. 17, three points RBG#2(I₁), RBG#2(I₂), and RBG#5(I₃) are reported, and RBG#3 to RBG#5(I₃), which is a wider frequency band, is allocated as a frequency band used for data transmission. Also, it is shown that a signal corresponding to a hatched region in the diagram, which is a narrower frequency band, that is, RBG#2(I₁ to I₂) which is a resource block group adjacent to the allocated frequency band and which is adjacent on the lower frequency side, is clipped. Also in this case, the control information transmitter 217 generates control information of frequency band allocation by using the above-described equations (22) and equation (23). In the example in FIG. 17, I₁ is the start position of frequencies in the case where a signal before being subjected to removal processing is allocated, I₂+1 is the start position of frequencies actually used for transmission, and I₃ is the end position of frequencies actually used for transmission.

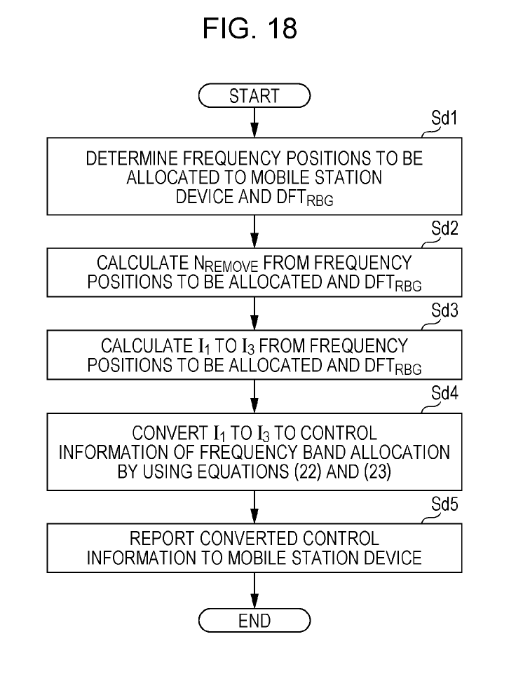

FIG. 18 is a flowchart describing the operation of the control information generator 216 and the control information transmitter 217 according to the present embodiment. Firstly, the control information generator 216 determines frequency positions that the mobile station device actually uses for data transmission and a frequency bandwidth N_{ALLOC}, and determines DFT_{RBG} which is the length of a signal before being subjected to removal processing (Sd1). Note that N_{ALLOC} and DFT_{RBG} are set to satisfy the following expression in order that a bandwidth to be clipped becomes narrower than the allocated bandwidth:

N_{ALLOC}>DFT_{RBG}−N_{ALLOC} expression (25)

The frequency positions are determined by taking into consideration channel state information of the mobile station device and the channel of another mobile station device to which data is transmitted at the same time in frequency multiplexing. Since the length of a signal to be removed is uniquely determined from DFT_{RBG} and N_{ALLOC}, the length is substantially determined in step Sd1. The control information generator 216 calculates N_{REMOVE} from the frequency positions and DFT_{RBG} determined in step Sd1 (Sd2). Next, the control information transmitter 217 calculates I₁ to I₃ from the frequency positions and DFT_{RBG} determined in step Sd1 (Sd3). Using equations (22) and equation (23), the control information transmitter 217 converts these I₁ to I₃ to control information of frequency band allocation (Sd4), outputs the control information to the transmitter 218, and reports the control information to the mobile station device 11 (Sd5)

The control information processor 111 of the mobile station device 11 extracts I₁ to I₃ from the control information FG of frequency band allocation, among pieces of control information received from the receiver 120. Here, the method of extracting I₁ to I₃ is the same as the first and second embodiments shown in FIG. 9 except for steps Sb2 and Sb6. In the present embodiment, the determination in step Sb2 becomes the following expression:

$$\begin{matrix}[ Math . 14 ] & \\ Q > 〈 \begin{matrix}{N}_{RBG} - s \\ 3 - i + 1\end{matrix} 〉 & expression ( 26 )\end{matrix}$$

Also, the determination in step Sb6 is whether i>3 is satisfied. The control information processor 111 calculates DFT_{RBG}, the number of RBGs of a transmit signal output from the DFT unit 103, by using equation (27):

DFT_{RBG}=I₃−I₁+1 equation (27)

The control information processor 111 regards, as the position of a signal to be removed, RBGs between two RBG indices selected, from among I₁ to I₃, on the basis of a predetermined rule. Here, the control information processor 111 selects two indices with a smaller difference from among these RBG indices. That is, regarding a signal to be removed, when the RBG indices satisfy I₂−I₁+1>I₃−I₂, the start RBG of a signal to be removed is I₂+1, and the number of RBGs is I₃−I₂. In contrast, when the RBG indices satisfy I₃−I₂>I₂−I₁+1, the start RBG of a signal to be removed is I₁, and the number of RBGs is I₂−I₁+1. Thus, the number of RBGs of a signal to be removed is calculated as N_{REMOVE} in equation (28):

N_{REMOVE}=min{I₂−I₁+1,I₃−I₂} equation (28)

where min {A, B} is a smaller value out of A and B.

Here, two RBG indices with a smaller difference are selected from among the three RBG indices, and RBGs between the selected RBG indices are removed. However, frequency positions to be clipped and a frequency band to be allocated may be determined on the basis of a predetermined rule. For example, two larger indices or two smaller indices may be selected, and RBGs between the selected RBG indices may be removed.

In the example where I₃−I₂>I₂−I₁+1 is satisfied, as shown in FIG. 17, a signal in the frequency domain corresponding to smaller RBG indices is removed, and transmission is performed. When I₂−I₁+1>I₃−I₂ is satisfied, a signal at a frequency position determined in advance between the mobile station device 11 and the base station device 20 may be removed. For example, the predetermined frequency position may be a greater one or a smaller one among the RBG indices.

A bit size required for control information of frequency band allocation of the present embodiment is expressed by the following expression (29) since three indices are specified:

ceil(log₂((N_{RBG}+1)N_{RBG}(N_{RBG}−1)/3!)) expression (29)

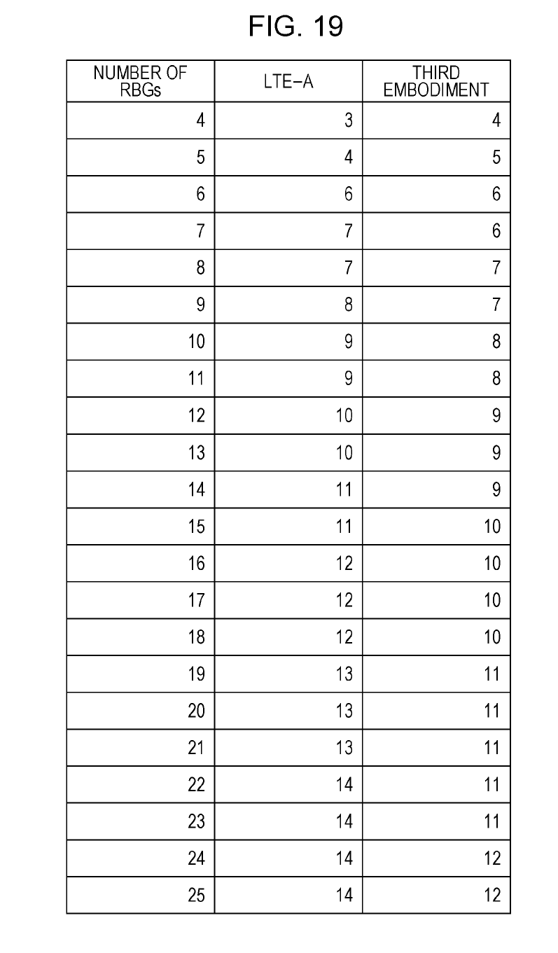

FIG. 19 is a table comparing the number of bits of control information of frequency band allocation in Clustered DFT-S-OFDM in LTE-A and the number of bits of control information of frequency band allocation in the present embodiment. Here, the case where the total number of resource block groups is 4 to 25 will be discussed. From this diagram, when the number of resource block groups is greater than or equal to 9, the number of bits becomes smaller in the present embodiment than in LTE-A. These unused bits may be used as a flag for reporting an RBG index for removing a signal in the frequency domain in the case of I₂−I₁+1=I₃−I₂.

As described above, since the information indicating frequency positions to be clipped, determined by the control information generator 216 of the base station device 20, is reported to the mobile station device 11, and the removal processor 105 of the mobile station device 11 performs clipping in accordance with the information, clipping in accordance with the state of the channel can be performed. Also, because the information indicating frequency positions to be clipped is included in control information of frequency band allocation that specifies only three frequency positions, the number of bits becomes smaller than the number of bits of control information of frequency band allocation in Clustered DFT-S-OFDM in LTE-A. Therefore, reduction of transmission efficiency caused by an increase in control information can be prevented.

In the above-described embodiments, the mobile station devices may perform MIMO (Multiple Input Multiple Output) transmission using multiple antennas or data transmission using a transmission diversity scheme or the like. Some of the mobile station devices may perform data transmission using a single antenna, and the remaining mobile station device(s) may perform MIMO using multiple antennas or a transmission diversity scheme.

A program running on the mobile station devices and the base station device according to the above-described embodiments is a program that controls a CPU or the like (program causing a computer to function) to realize the functions of the above-described embodiments. Information handled by these devices is temporarily accumulated in a RAM when the information is processed, thereafter stored in various ROMs or an HDD, and, as occasion calls, read and modified/written by the CPU. A recording medium storing the program may be any of a semiconductor medium (such as a ROM, a non-volatile memory card, or the like), an optical recording medium (such as a DVD, MO, MD, CD, BD, or the like), a magnetic recording medium (such as a magnetic tape, a flexible disk, or the like), or the like.

Not only the functions of the above-described embodiments are realized by executing the loaded program, but also the functions of the present invention may be realized by cooperatively performing processing with an operating system, another application program, or the like on the basis of instructions of the program. To distribute the program in the marketplace, the program may be distributed by storing the program on a transportable recording medium, or the program may be transferred to a server computer connected via a network such as the Internet. In this case, a storage device of the server computer is also included in the present invention.

Part or entirety of the mobile station devices and the base station device according to the above-described embodiments may be realized as an LSI which is typically an integrated circuit. The function blocks of the mobile station devices and the base station device may be individually implemented as chips, or part or entirety thereof may be integrated and implemented as a chip. Also, the implementation of integrated circuitry is not limited to an LSI and may be realized by a dedicated circuit or a general processor. Also, when integrated circuitry technology that replaces an LSI emerges as a result of the development of integrated circuitry technology, an integrated circuit based on this technology can be used.

The embodiments of the present invention have been described so far in detail with reference to the drawings. However, specific configurations are not limited to the embodiments, and designs or the like within a scope not departing from the gist of the invention are also included in the claims.

### DESCRIPTION OF REFERENCE NUMERALS

10 wireless communication system
11, 12, 13 mobile base stations
20 base station device
101 encoder
102 modulator
103 DFT unit
105 removal processor
106 mapping unit
107 IFFT unit
108 reference signal multiplexer
109 transmission processor
110 antenna
111 control information processor
112 reference signal generator
120 receiver
201 antenna
202 reception processor
203 reference signal separator
204 FFT unit
205 de-mapping unit
206 software canceller
207 equalizer
209 IDFT unit
210 demodulator
211 decoder
212 replica generator
213 DFT unit
214 removal processor
215 channel estimation unit
216 control information generator
217 control information transmitter
218 transmitter

1. A communication system comprising a first communication device that transmits a signal in the frequency domain, part of the signal being removed, and a second communication device that receives the transmitted signal,
wherein the second communication device determines a signal to be removed by the first communication device, and transmits information indicating the position of the signal to be removed, and
wherein the first communication device receives the information indicating the position of the signal to be removed, removes part of the signal in the frequency domain on the basis of the information, and transmits the signal.

2. The communication system according to claim 1,
wherein the second communication device determines a frequency band used by the first communication device for transmission, and
wherein the information indicating the position of the signal to be removed includes information indicating at least three frequency positions.

3. The communication system according to claim 2, wherein the position of the signal to be removed is between two frequency positions selected, from among the three frequency positions, on the basis of a predetermined rule.

4. The communication system according to claim 2, wherein the predetermined rule selects, from among the three frequency positions, two frequency positions with the smallest difference.

5. The communication system according to claim 2, wherein the information indicating the position of the signal to be removed includes information indicating four frequency positions.

6. A communication method for a communication system including a first communication device that transmits a signal in the frequency domain, part of the signal being removed, and a second communication device that receives the transmitted signal, comprising:
a first step of determining, by the second communication device, a signal to be removed by the first communication device, and transmitting information indicating the position of the signal to be removed; and
a second step of receiving, by the first communication device, the information indicating the position of the signal to be removed, removing part of the signal in the frequency domain on the basis of the information, and transmitting the signal.
